(19) United States
(12) Patent Application Publication
(10) Pub. No.: US 2005/0157179 A1
(43) Pub. Date: Jul. 21, 2005

(54) Image photographing apparatus

(75) Inventors: Min-Ho Cha, Seoul (KR); Hee-Sun Tak, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/034,973

(22) Filed: Jan. 14, 2005

(30) Foreign Application Priority Data
Jan. 17, 2004 (KR) 2004-3566

(51) Int. Cl. H04N 5/225

(52) U.S. Cl. 348/207.99

(57) ABSTRACT

An image photographing apparatus comprises a camera unit that may be rotated according to photographing positions. The camera unit is mounted on a body. A storage member is disposed in the body. A plurality of recording buttons are formed in the body for directing photographing conveniently according to positions of the rotatable camera unit.

### CROSS-REFERENCE TO RELATED APPLICATIONS

This application claims the benefit under 35 U.S.C. § 119 (a) of Korean Patent Application No. 2004-3566 filed Jan. 17, 2004, in the Korean Intellectual Property Office, the entire disclosure of which is hereby incorporated by reference.

### BACKGROUND OF THE INVENTION

1. Field of the Invention

The present invention relates to an image photographing apparatus for photographing, storing and restoring an image. More particularly, the present invention relates to an image photographing apparatus, such as a digital camera, a camcoder, and a dual-camcoder, having improved user manipulability.

2. Description of the Related Art

Generally, an image photographing apparatus includes a camera unit for photographing an image, a body on which the camera unit is mounted, and storage for storing a photographed image.

Since a conventional image photographing apparatus has a camera unit fixed to its body, the whole image photographing apparatus is moved to change the position of the camera unit. Thus, the photographing posture of a user is often uncomfortable and unstable depending on the photographer's position. The uncomfortable and unstable photographing posture causes shaking or vibrating of the camera unit, thereby degrading the image quality.

Therefore, a need exists for a image photographing apparatus having improved structure to eliminate uncomfortable and unstable photographer positions, thereby resulting in improved image quality.

### SUMMARY OF THE INVENTION

An object of the present invention is to provide an image photographing apparatus with an improved structure that gives a user a sense of stability during photographing and allows the user to select and use a recording button with convenience according to the positions of a camera unit.

In accordance with one aspect of the present invention, there is provided an image photographing apparatus including a camera unit that may be rotated according to photographing positions, a body on which the camera unit is mounted, a storage member set up in the body, and a plurality of recording buttons formed in the body for directing photographing conveniently according to a position of the rotatable camera unit.

The recording buttons are formed on the upper and side surfaces of the body, respectively.

The body of the image photographing apparatus further includes housing grooves and, preferably, the recording buttons are formed in the inside of the housing grooves to prevent interference with the camera unit during rotation of the camera unit.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view of an image photographing apparatus in accordance with an embodiment of the present invention;

FIG. 2 is a perspective view of a camera unit of FIG. 1 rotated in the direction of arrow “B”;

FIG. 3 is a perspective view of the manipulation of a first recording button of FIG. 1; and

FIG. 4 is a perspective view of the manipulation of a second recording button of FIG. 2.

Throughout the drawings, like reference numerals will be understood to refer to like parts, components and structures.

### DETAILED DESCRIPTION OF EXEMPLARY EMBODIMENTS

Exemplary embodiments of the present invention will be described in greater detail with reference to the accompanying drawings. The matters defined in the description, such as a detailed construction and elements thereof, are provided to assist in a comprehensive understanding of the invention. Thus, it is apparent that the present invention may be carried out without those defined matters. Also, descriptions of well-known functions or constructions are omitted for conciseness.

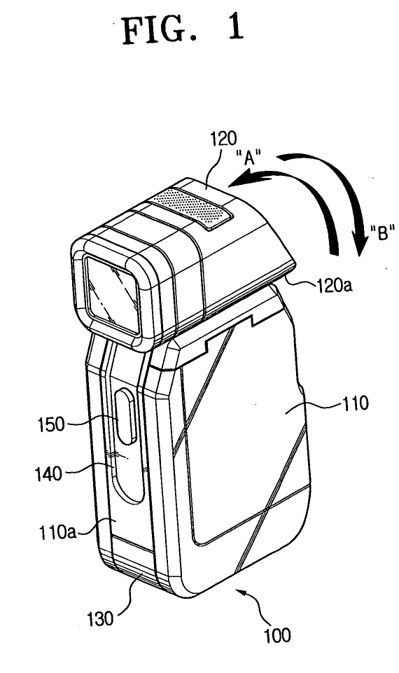

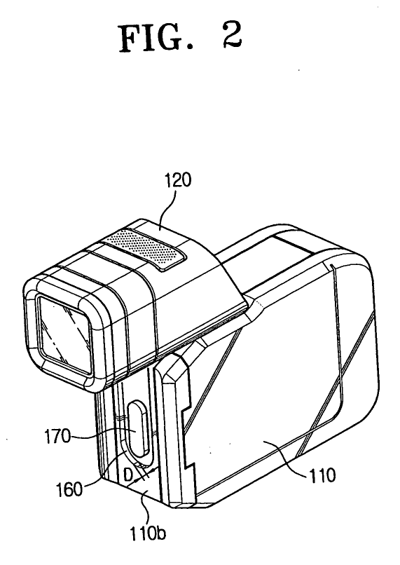

Referring to FIGS. 1 and 2, the image photographing apparatus 100 comprises a body 110, a camera unit 120, a storage member 130, a first recording button 150, and a second recording button 170.

The body 110 includes a storage member 130 for storing a photographed image. The first recording button 150 and the second recording button 170 start or terminate photographing conveniently according to a rotation position of the camera unit 120.

Preferably, the first recording button 150 is formed on the left side 110a of the body 110 and the second recording button 170 is formed on the upper surface 110b of the body 110. For the first and second recording buttons, a first housing groove 140 for the first recording button 150 is formed on the left side 110a of the body 110, and a second housing groove 160 is formed on the upper surface 110b of the body 110.

The first recording button 150 is disposed in the first housing groove 140 formed on the left side 110a of the body 110. The second recording button 170 is disposed in the second housing groove 160 formed in the upper surface 110b of the body 110. The second housing groove 160 has a depth D sufficiently deep so that the rotation of the camera unit 120 does not interfere with the second recording button 170.

The lower part 120a of the camera unit 120 is connected to the upper surface 110b of the body 110 with a hinge (not shown) so that the camera unit 120 may be rotated or pivoted according to a photographing position. Preferably, the camera unit 120 is rotatably or pivotally connected to the body 110. With this structure, the camera unit 120 may be rotated in both directions, i.e., the direction indicated by arrow “A” or in the direction indicated by arrow “B” of FIG. 1.

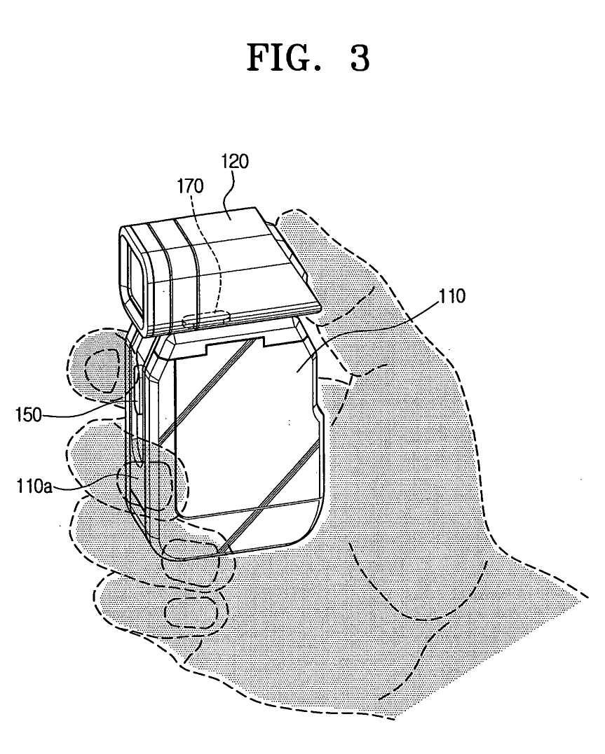

Referring to FIG. 3, if the user feels comfortable in photographing when the camera unit 120 is positioned on the upper surface 110b of the body 110, the user may move the camera unit 120 from the position shown in FIG. 2 to the position shown in FIG. 1 by rotating the camera unit 120 in the direction indicated by arrow “A”.

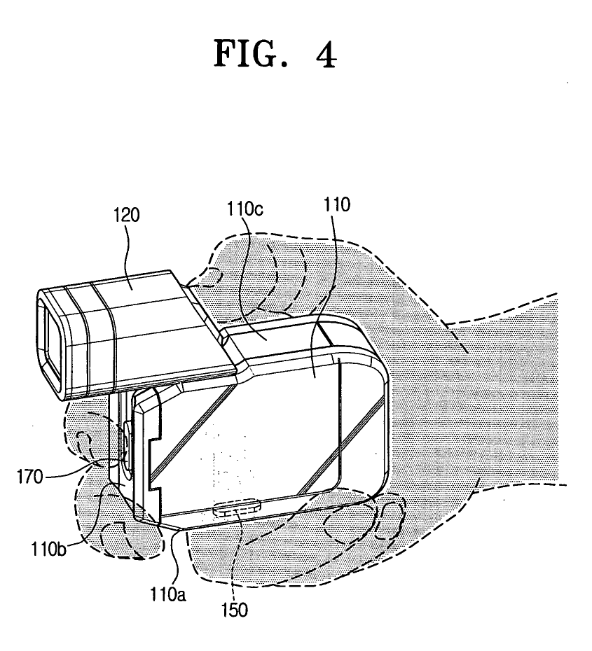

If the camera unit 120 is positioned as shown in FIG. 1, the user cannot use the second recording button 170 on the upper surface 110b of the body 110 but may use the first recording button 150 on the left side 110a of the body 110 instead, which is shown in FIG. 3. In a first position shown in FIG. 1, access to the second recording button 170 is prevented by the camera unit 120. In a second position shown in FIG. 2, the first recording button 150 is accessible, as shown in FIG. 4.

As illustrated in FIG. 3, the user may start or terminate photographing by holding the image photographing apparatus with their middle, ring and little fingers put on the left side 110a of the body 110 and their thumb put on the upper side of the camera unit 120, and pressing the first recording button 150 on the left side 110a of the body 110 with the index finger.

Referring to FIG. 4, if the user feels more comfortable in photographing when the camera unit 120 is positioned on the right side 110c of the body 110, the user may move the camera unit 120 from the position of FIG. 1 to the position of FIG. 2 by rotating the camera unit 120 in the direction indicated by arrow “B”.

In the position shown in FIG. 4, the user may use the first recording button 150 on the left side 110a of the body 110 and the second recording button 170 on the upper surface 110b of the body 110 selectively. However, it is more convenient to use the second recording button 170 on the upper surface 110b of the body 110, as shown in FIG. 4.

As illustrated in FIG. 4, the user may start or terminate photographing by holding the image photographing apparatus with the ring and little fingers put on the left side 110a of the body 110, the middle finger put on the upper surface 110b of the body 110, and the thumb put on the upper side of the camera unit 120, and pressing the second recording button 170 on the upper surface 110b of the body 110 with the index finger.

In accordance with the embodiment of the present invention described above, the image photographing apparatus has a camera unit that may be rotated freely according to a photographing position, which provides a user with a free and stable photographing posture, whereas that of a conventional image photographing apparatus is fixed.

Since the image photographing apparatus of the present invention adopts two recording buttons in consideration of the possible difficulty in manipulating a recording button due to the rotatable camera unit, the user may selectively use a recording button that is convenient to use.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

1. An image photographing apparatus, comprising:
a rotatable camera unit;
a body on which the camera unit is rotatably mounted;
a storage member disposed in the body; and
a plurality of recording buttons to conveniently direct photographing according to a position of the rotatable camera unit, the recording buttons being formed on the body.

2. The image photographing apparatus as recited in claim 1, wherein
the body includes the recording buttons formed on the upper and side surfaces, respectively.

3. The image photographing apparatus as recited in claim 2, wherein
housing grooves are formed in the body, and each of the plurality of recording buttons are mounted on the inside of one of the housing grooves to prevent interference with the camera unit.

4. An image photographing apparatus, comprising:
a pivotable camera unit;
a body on which the camera unit is pivotably mounted;
a plurality of recording buttons disposed on the body; and
a plurality of grooves formed in the body, each of the plurality of recording buttons being disposed in one of the plurality of grooves.

5. The image photographing apparatus as recited in claim 4, wherein
a storage member is disposed in the body.

6. The image photographing apparatus as recited in claim 4, wherein
at least one of the plurality of grooves has a first depth greater than a second depth of the recording button disposed therein.

7. An image photographing apparatus, comprising:
a pivotable camera unit movable between first and second positions;
a body on which the camera unit is pivotably mounted;
first and second grooves formed in the body; and
first and second recording buttons disposed in the first and second grooves, respectively, wherein the second recording button is inaccessible when the camera unit is in the first position and the first and second recording buttons are accessible when the camera unit is in the second position.

8. The image photographing apparatus as recited in claim 7, wherein
the second groove has a first depth greater than a second depth of the second recording button to substantially prevent interference with the camera unit when in the first position.
